(19) United States
(12) Patent Application Publication
(10) Pub. No.: US 2008/0290615 A1
(43) Pub. Date: Nov. 27, 2008

(54) Chuck for the Holding of Fastening Elements for a Friction-Welded Connection

(75) Inventor: Dieter Mauer, Lollar (DE)

Correspondence Address: BIRCH STEWART KOLASCH & BIRCH, PO BOX 747, FALLS CHURCH, VA, 22040-0747, US

(73) Assignee: EJOT GMBH & CO. KG, Bad Laasphe (DE)

(21) Appl. No.: 11/658,471

(22) PCT Filed: Jul. 19, 2005
(86) PCT No.: PCT/EP05/07852

§ 371 Date: May 19, 2007

(30) Foreign Application Priority Data
Aug. 13, 2004 (DE) 10 2004 039 398.2

(51) Int. Cl. B23B 31/02

(52) U.S. Cl. 279/156

(57) ABSTRACT

The invention relates to a chuck (2) for retaining fixing elements (1) that are provided with a respective radial contact surface and a follower profile (17) for a friction welded connection on a component and for transmitting the rotational and contact forces that act on a fixing element. An annular receiving element (9) is provided in the chuck (2) for transmitting the rotational force, said receiving element tightly surrounding the fixing element comprising an axial polygonal profile that has been introduced. The chuck comprises a retractable contact part (18, 27) in the annular receiving element (9), which is guided in said element and which can be retracted in said element to permit the entry of a fixing element through a lateral opening (12) in the receiving element, the part being retracted behind said opening. After the introduction of a fixing element, the contact part can be displaced into a holding position against the contact surface (19) of the fixing element, in such a way that the fixing element presses against the component in the friction welding position during its rotation. In the holding position, the fixing element that has been introduced into the annular receiving element is held axially by retractable stop parts (10, 11) that project radially inwards.

The invention relates to a chuck for the holding of fastening elements, each provided with a radial pressure surface and a driving profile, for a friction-welded connection to a component and for the transmission of rotational and pressing forces acting on a fastening element.

Such a chuck is presented and described in U.S. Pat. No. 4,850,772. The known chuck is adapted to a specific fastening element comprising a threaded stud, the front face of said threaded stud forming a surface which is to be joined by friction-welding to the respective component. The stud has a flange spaced from the front face, said flange being designed to transmit the rotational force and the pressing force, such that its side facing away from the front face of the stud is slightly conical in form and is provided with successive flutes which are oriented radially with their ridges. Said thus oriented flutes together form the aforementioned cone and serve to be received by a correspondingly shaped chuck which then takes up the rotational force via the flutes and the pressing force via the radial extent of the flange and transmits said forces via the shank of the stud to the front face thereof for friction-welding. Since, in the friction-welding process which underlies the stud, it is necessary to apply both considerable rotational forces and also pressing forces, the fluted design of the aforementioned surface of the flange may mean that the slopes of the individual flutes impart to the chuck of the employed friction-welding device the tendency to be rhythmically forced away from the flange, which may result in a shaking motion, above all in the axial direction, this being detrimental for the friction-welding operation. The rotational and pressing forces acting on the stud are applied in common by a pressure piece having a central hole. The stud is inserted into the hole of the pressure piece until its flange comes up against a front face of the pressure piece which is adapted to the respective face of the flange, i.e. which is likewise conical in form and provided with flutes. The flutes of the pressure piece fit into the flutes of the flange. Apart from the fact that the design of the flange taking up the rotational and pressing forces may lead to the aforementioned problem of the occurrence of a shaking motion, the known chuck is suitable only for the single processing of studs, because each stud to be friction-welded to a component must be introduced by hand into the chuck in a direction opposite to the subsequent pressing direction. Said chuck, therefore, is not suitable for the automated feeding of studs, this constituting a further disadvantage of the known chuck.

The object of the invention is to create a chuck of the above-described kind for the holding of fastening elements for a friction-welded connection, wherein, on the one hand, said chuck allows the automated feeding of fastening elements and, on the other hand, the application of the rotational force and pressing force is effected in such a manner that the guiding of the respective fastening element both in the axial direction of the pressing force and also the pressing force itself can be dosed with particular accuracy, in order to permit a friction-welded connection which, while providing a secure weld, removes material from the fastening element and the component only to the smallest possible extent, with the consequence that, in particular, thin components, i.e. in particular, thin metal plates, are suitable for a friction-welded connection. The object of the invention is achieved in that the chuck is provided with an annular receptacle for transmitting the rotational force, said annular receptacle snugly embracing the inserted fastening element, said fastening element having an axial multi-sided profile, wherein the chuck comprises a pressure piece, said pressure piece being adapted to be pulled away from the annular receptacle, wherein said pressure piece is guided by a tube terminating in the annular receptacle and is, for the feeding of a fastening element through a lateral opening on the tube, retractable in the tube to behind the opening and is, after insertion of a fastening element, advanceable into a waiting position against the pressure surface of the fastening element such that, in the friction-welding position, the fastening element presses during its rotation against the workpiece, wherein, in the waiting position, the fastening element, inserted into the annular receptacle, is axially held in its end position in the annular receptacle by radially inwardly projecting, retractable arresting parts.

In the chuck according to the invention, separate tool elements are used for application, on the one hand, of the rotational force and, on the other hand, of the pressing force; namely, for the rotational force, use is made of the annular receptacle, which is adapted to an axial multi-sided profile of the fastening element engaged by the chuck and which snugly embraces said multi-sided profile. The pressing force is applied by a pressure piece, said pressure piece being adapted to be retractable in the annular receptacle and being guided in the annular receptacle. The pressure piece can be retracted so far in said annular receptacle that a new fastening element for processing can each time be introduced through a lateral opening on the annular receptacle, without said fastening element being obstructed by the pressure piece, which pressure piece can be retracted to behind the opening. Said multi-sided profile may, for example, be a hexagonal profile, as is conventionally used, for example, in the case of hexagonal bolts and hexagonal nuts. Of course, however, it is alternatively possible to employ a different multi-sided profile, more particularly a square profile. For the friction-welding operation, the pressure piece is then pressed inside the annular receptacle against the fastening element, said fastening element having the aforementioned radial pressure surface for taking up the pressing forces. Such a design ensures that the rotational force and the pressing force are each individually applied and can therefore be adjusted with corresponding accuracy, since the adjustment of each force cannot in any manner be adversely affected by the other force. In order to ensure that, once inserted, a fastening element is held in its waiting position for the friction-welded connection, the annular receptacle is provided with radially inwardly projecting retractable arresting parts that catch the fastening element, which has been introduced through the lateral opening on the annular receptacle, and hold the fastening element securely in position up until processing.

In order to ensure that, having been introduced into the chuck, the fastening element is provided with a secure support in the annular receptacle, the annular receptacle is advantageously of such design that it narrows its external opening in the direction away from the pressure piece as far as contact with the fastening element. Upon sliding into the external opening with its driving profile, the fastening element is then securely held in the axial direction through engagement of the driving profile by the annular receptacle, thereby allowing the following friction-welding operation to take place with precise centering.

In order, also with the arresting parts retracted prior to commencement of the actual friction-welding operation, to provide the fastening element in the chuck with a certain support in the chuck, for the processing of stud-type fastening elements, the pressure piece is provided in the region of its hole with thereinto partially projecting clamping pieces, wherein said clamping pieces clamp in easily releasable manner in the waiting position a shank of the fastening element, said shank being held by the hole. For the processing of a nut-type fastening element, the pressure piece is provided with an axially protruding pin, wherein, when the pressure piece presses against the fastening element in the waiting position, said pin projects with a ram-type clamping piece into the threaded hole of the nut-type fastening element and clamps itself releasably therein. Both embodiments then allow the respective fastening element to be pulled away without problem, because, as has been stated, the holding or clamping function of the respective clamping piece is releasable.

To allow the arresting parts to be moved such that they release a fastening element which they have been holding back, the arresting parts are advantageously provided with a conical support surface for a fastening element which has been introduced, over which support surface the fastening element slides, forcing the arresting parts away to the side, as the fastening element moves into the friction-welding position. When the pressure piece comes up against the radial pressure surface of the respective fastening element, this then results, owing to the conical support surface on the arresting parts, in a radially outwardly directed force component which forces the arresting parts away, thereby releasing the fastening element to proceed further to the friction-welding position.

In order to ensure that, as the fastening elements are being fed to the chuck, their driving profile is already at an early stage given a position from which the fastening elements are able to slide without obstruction into the annular receptacle, a feed channel may be connected to the lateral opening on the annular receptacle, said feed channel transitioning with constant narrowing of its interior space as far as adapting to the multi-sided profile of the annular receptacle. In this manner, as they slide in the feed channel towards the chuck, the fastening elements are already at an early stage given an angular position in which they can then slide without obstruction into the annular receptacle with their shape adapted to the multi-sided profile of the fastening elements.

In order, during the friction-welding operation, which operation is based on controlling the rotational speed of the fastening element, to minimize the moments of inertia of the rotating components, the chuck is advantageously of such design that a non-rotatable ram, axially displaceable in the annular receptacle, is provided for displacement of the pressure piece, wherein said ram axially drivingly and releasably engages the pressure piece on the side thereof facing away from the fastening element, wherein, when the fastening element reaches the friction-welding position, the pressure piece locks itself with the annular receptacle in such a manner that the annular receptacle transmits the thereon acting rotational forces, together with the pressing forces, to the pressure piece, the ram being released from the pressure piece.

An illustrative embodiment of the invention is presented in the drawings, in which:

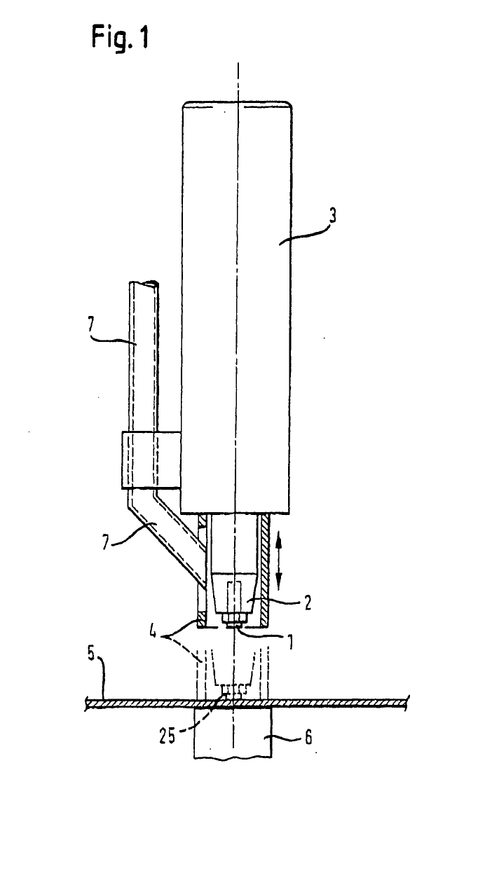

FIG. 1 shows the chuck together with its driving mechanism;

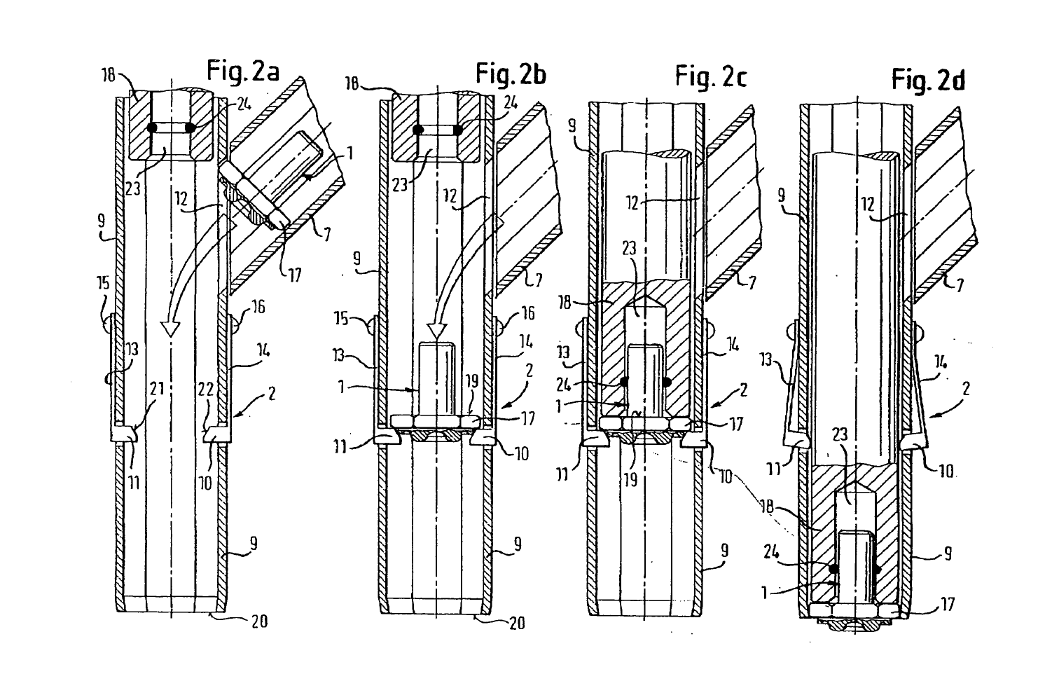

FIGS. 2a-d show the chuck on its own for the processing of a stud-type fastening element in its individual operating phases from the feeding through to the friction-welding of a fastening element;

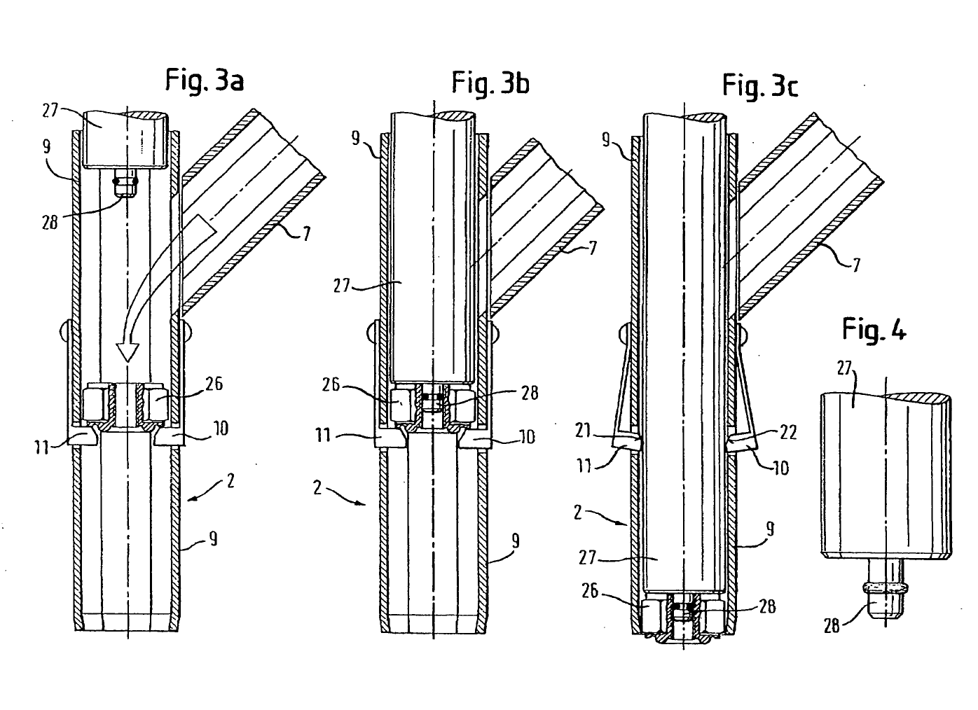

FIGS. 3a-c show the chuck on its own for the processing of a nut-type fastening element in three working positions of already introduced fastening elements for the friction-welding of the fastening element;

FIG. 4 shows the pressure piece with a protruding pin for holding a nut-type fastening element;

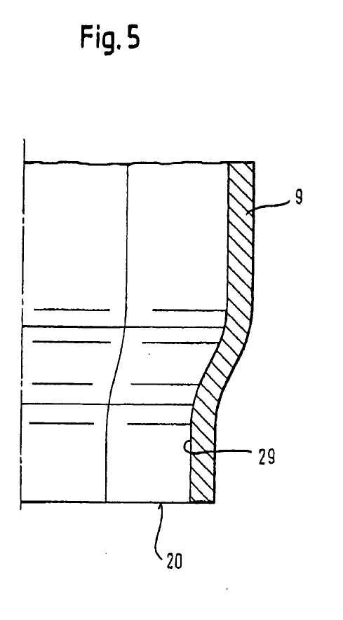

FIG. 5 shows an enlarged representation of the end of the annular receptacle for embracing an introduced fastening element;

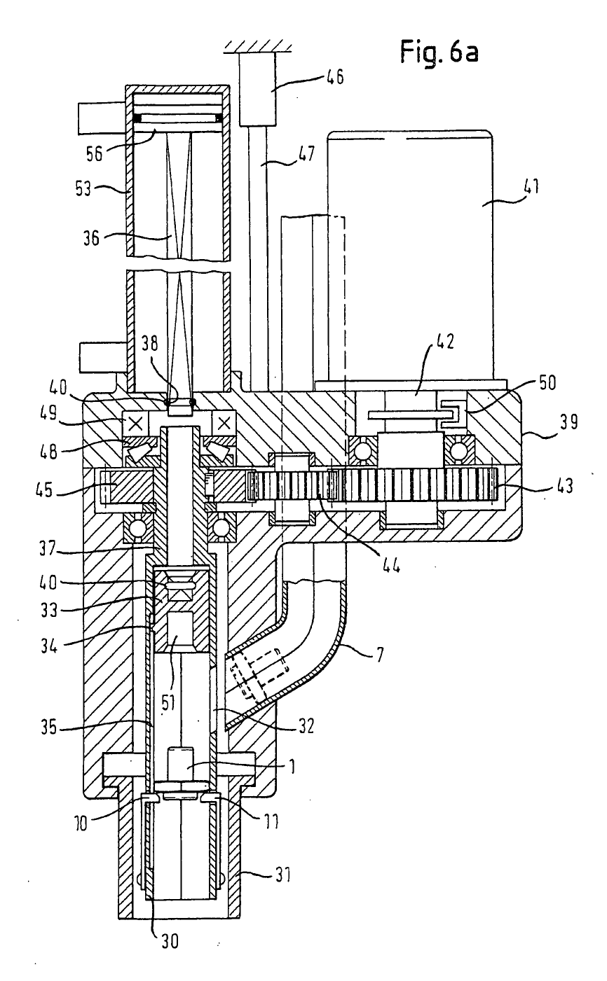

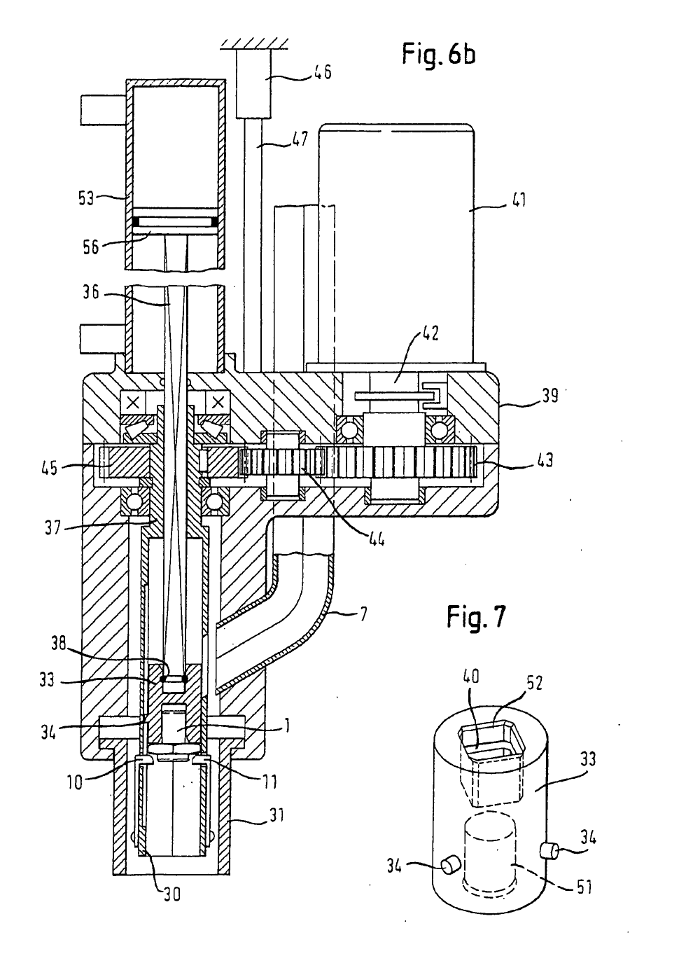

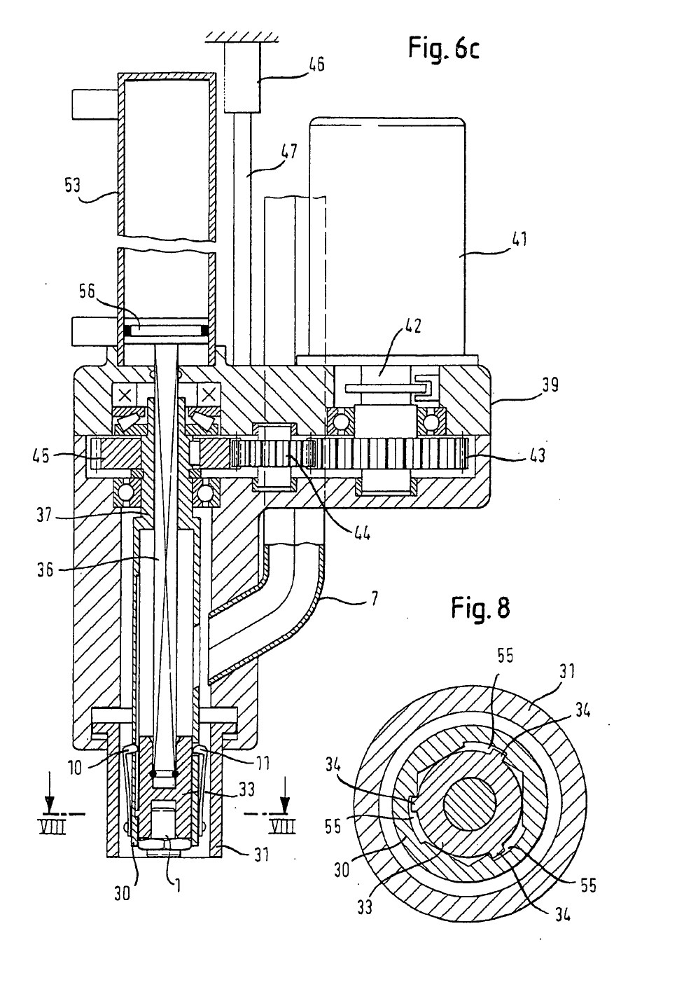

FIG. 6a shows a chuck of special design with regard to the rotating masses, together with its driving mechanism, and with a fastening element in the waiting position;

FIG. 6b shows the chuck with its driving mechanism in the phase prior to transfer of a fastening element, held by the pressure piece, into the friction-welding position;

FIG. 6c shows the chuck with its driving mechanism, with the fastening element having been transferred into the friction-welding position;

FIG. 7 shows the pressure piece in a perspective view from the chuck presented in FIGS. 6a to 6c;

FIG. 8 shows the locking mechanism between chuck and annular receptacle, in section;

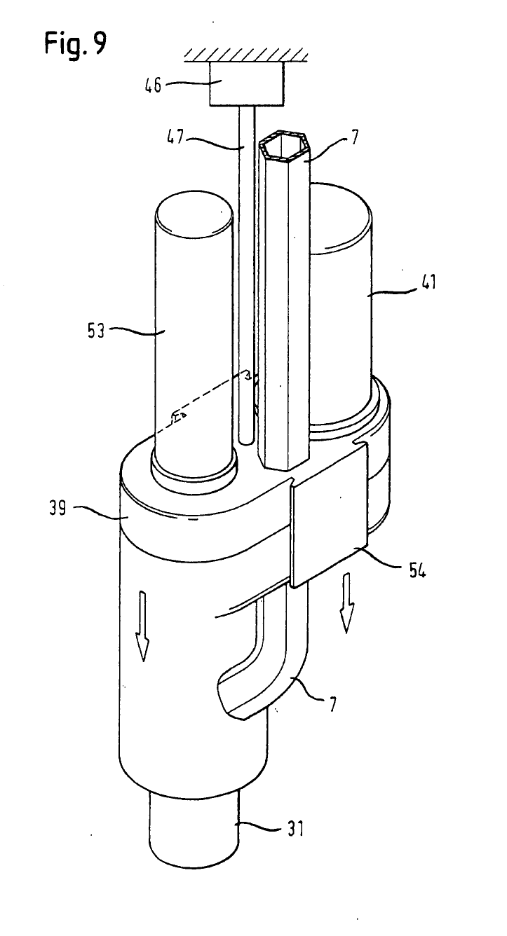

FIG. 9 shows an overall view of the arrangement with laterally attached driving mechanism;

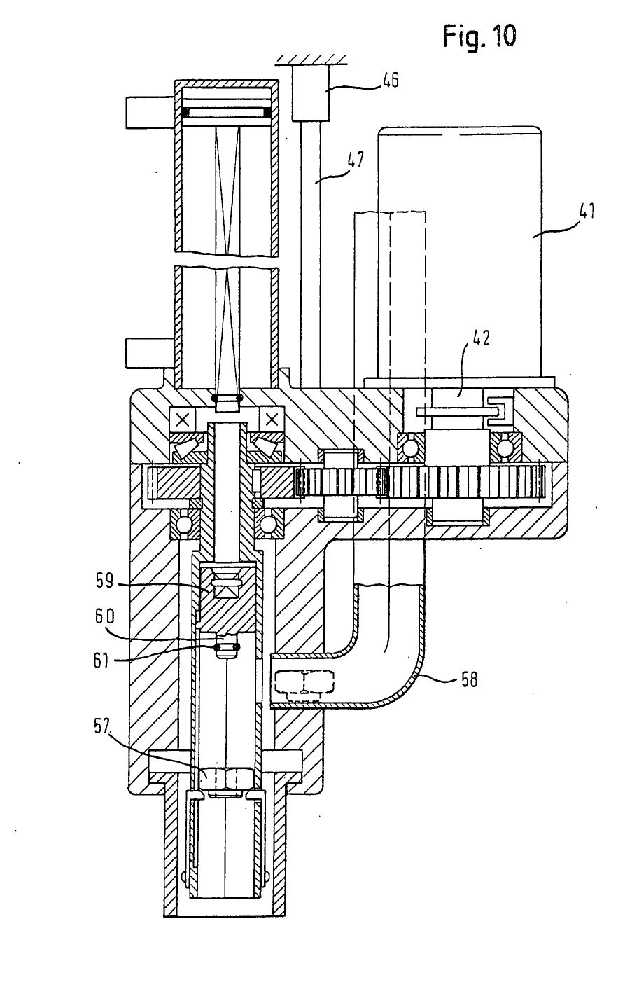

FIG. 10 shows a device according to that from FIG. 6a for the processing of fastening elements in the form of nuts.

FIG. 1 shows a general representation of a device for the friction-welding of the fastening element 1, said device comprising the chuck 2, which is driven by the driving mechanism 3. The driving mechanism 3 itself is not a subject matter of the present invention and is, therefore, only generally represented as a module of the device. The chuck 2 is surrounded by the downholder 4, which, together with the chuck 2, is adapted to be lowered onto the component 5 and presses said component during the friction-welding operation in known manner against the abutment 6. The chuck 2 is supplied successively via the tube 7 with the fastening elements which are to be processed, said tube 7 merging at an angle from the side into the chuck 2; this will be more fully discussed hereinbelow. A detailed representation of the device is contained in German patent application 10 2004 034 498.1, to which reference is herewith made.

FIGS. 2a to d present the chuck 2 in the individual operating phases for the processing of stud-type fastening elements 1.

The chuck 2 comprises the annular receptacle 9, which is of such length that one new fastening element 1 at a time can be fed through the tube 7, which merges at an angle into the annular receptacle 9, said fastening element 1 sliding from the operating position shown in FIG. 2a into the operating position shown in FIG. 2b, where it is held in a waiting position by the arresting parts 10 and 11. To allow such feeding of the fastening elements, the annular receptacle 9 is provided with the lateral opening 12, which adjoins, with a small gap, the end of the tube 8, said end of the tube 7 maintaining a small gap from the wall of the annular receptacle 9, because, during further processing, the annular receptacle 9 is set in rotation for the friction-welding operation.

The two arresting parts 10 and 11 are attached to the annular receptacle 9 via the spring elements 13 and 14 by means of rivets 15 and 16. The spring elements 13 and 14 allow the arresting parts 10 and 11 to yield to the side (see FIG. 2d) in order to release the fastening element 1 which is held in the waiting position (see FIG. 2b), out of which waiting position the fastening element 1 can be transferred into the friction-welding position as shown in FIG. 2d.

The chuck presented in FIGS. 2a-d is, as has been stated, intended for the processing of stud-type fastening elements 1 having a hexagonal axial multi-sided profile 17, i.e. for fastening elements which, in that respect, resemble a hexagon head bolt. Said multi-sided profile is provided also for the annular receptacle 9, likewise also for the tube 7 for the feeding of new fastening elements, with the result that, already out of the tube 7, said fastening elements are supplied with their rotation angle correctly oriented for transfer to the annular receptacle 9 and are held in the annular receptacle 9.

Starting out from the waiting position as shown in FIG. 2b, wherein the fastening element is initially held in said waiting position by the arresting parts 10 and 11, the chuck 2 switches over into the position presented in FIG. 2c, in which the pressure piece 18, which was initially held in a retracted position as shown in FIGS. 2a and 2b, is lowered onto the fastening element 1, the pressure piece 18 striking the radial pressure surface 19 of the fastening element 1 and forcing the fastening element 1 towards the bottom end 20 of the annular receptacle 9, the arresting parts 10 and 11 being forced away to the side, since they are provided with the generally conical support surfaces 21 and 22 (see FIG. 2a), onto which support surfaces 21 and 22 the edge of the multi-sided profile 17 presses, thereby pivoting the arresting parts towards the outside (see FIG. 2d), this being made possible by the spring elements 13 and 14. When being thus lowered onto the fastening element 1, the pressure piece 18 embraces with its hole 23 the shank of the fastening element 1 and releasably clamps said shank by means of the clamping piece 24, which clamping piece 24 is contained in the pressure piece 18 in the region of the hole 23 thereof and is here in the form of an expandable rubber ring, said rubber ring being accommodated in a corresponding groove in the wall of the hole 23 and, as the pressure piece 18 presses on the shank of the fastening element 1, giving way slightly and releasably clamping the fastening element 1 under the tension of the rubber ring.

The end of the lowering movement of the pressure piece 18 is presented in FIG. 2d. The pressure piece 18 now presses with its front face with considerable axial pressure on the pressure surface 19 (see FIG. 2b) of the fastening element 1, the annular receptacle 9 at the same time being set in rotation, with the result that there now follows the friction-welding operation, which is shown in general principle in FIG. 1 and in which the required pressing forces and rotational forces are applied by the driving mechanism 3 presented in FIG. 1. This friction-welding position 25 of the chuck 2 is presented by the dashed line in FIG. 1.

FIGS. 3a to c present basically the same chuck 2, which, however, is of a design for the processing of nut-type fastening elements. Connected to the annular receptacle 9 is the tube 7 for the feeding of nut-type fastening elements, such connection being effected in the manner as described in connection with FIG. 2a. FIG. 3a shows the chuck 9 with a nut-type fastening element 26 in the waiting position, in which the fastening element 26 is resting on the two arresting parts 10 and 11. Then, under pressure from the pressure piece 27 on the rear surface of the fastening element 26, i.e. on its radial pressure surface, the arresting parts 10 and 11 are forced away, thereby releasing the fastening element 26. The fastening element 26 is then securely held by the annular receptacle 9 in the end position presented in FIG. 3c, whereupon the pressing forces and rotational forces applied by the driving mechanism 3 (see FIG. 1) act on the fastening element 26, thereby joining said fastening element 26 to a component 5 in the friction-welding position.

In order to ensure that, after introduction of a fastening element 26 into the annular receptacle 9, the fastening element is releasably held during the movement from the waiting position (as presented in FIG. 3b) into the friction-welding position (as presented in FIG. 3c) (see explanatory remarks with respect to FIG. 2c), the pressure piece 27 is provided with the protruding pin 28, which is insertable into the threaded hole in the fastening element 26 and is surrounded by an O-ring, said O-ring being held by a groove in the pin 28. The O-ring serves as a clamping piece and presses from inside against the surface of the threaded hole in the fastening element 26, thereby releasably securing the fastening element 26.

At the end of displacement of the respective fastening elements 1 and 26 into the respective friction-welding positions presented in FIGS. 2d and 3c, the fastening element must be so securely held by means of its multi-sided profile that it does not slip out of the annular receptacle and is held with as little play as possible during rotation. For this purpose, the end 20 (see FIG. 2c) of the annular receptacle 9 is of special design, as is presented in FIG. 5. Accordingly, the aforementioned end 20 is provided with such a narrowing 29 that, while a fastening element is able with its multi-sided profile to move smoothly into the friction-welding position, it is at the same time snugly held in said friction-welding position by means of the multi-sided profile, which multi-sided profile is provided also in the annular receptacle, for which purpose there is a very slight taper in the corresponding region of the annular receptacle. Consequently, in the region of said taper 29, the annular receptacle 9 makes snug contact around the multi-sided profile 17 of a fastening element, releasably holding said fastening element in the corresponding position and, during the friction-welding operation, thereby allowing—by taking up considerable pressing forces and rotational forces—the true rotation and, therefore, sure friction-welding of the corresponding component.

FIG. 6a presents a variation on the design shown in FIG. 1 of a device for the friction-welding of the fastening element 1, the fastening element 1 being in the waiting position. The fastening element 1 has been transferred into said waiting position from the position (shown by the dashed line) in the feeding tube 7. In the presented waiting position, the fastening element 1 is held by the arresting parts 10 and 11, the function of which is identical to that of the arresting parts 10 and 11 shown in FIGS. 2a to d. The arresting parts 10 and 11 in FIG. 6a are able, when pressure is exerted on the fastening element 1, to yield laterally towards the outside (see also the description in relation to FIG. 2b). The arresting parts 10 and 11 are attached to the annular receptacle 30, which is accommodated in axially movable manner in the tubular downholder 31. For friction-welding of the fastening element 1, the downholder 31 is brought down onto a corresponding workpiece (e.g. 5 in FIG. 1). The tubular downholder 31 is penetrated by the aforementioned feeding tube 7 for the supply of further fastening elements. A corresponding penetration 32 is provided also in the annular receptacle 30. The pressure piece 33 is guided in axially movable manner in the annular receptacle 30, said pressure piece 33 being adapted to be brought down onto the fastening element 1 by a hereinbelow described mechanism and to be thereafter pressed against a workplace, as will be described hereinbelow. The pressure piece 33 is provided with dogs 34 (see also FIG. 7), which dogs 34 engage correspondingly shaped grooves 35 in the annular receptacle 30, this ensuring that the pressure piece 33 is unable to turn in relation to the annular receptacle during axial movement out of the position presented in FIG. 6a into a position prior to friction-welding.

The transfer of the fastening element 1 presented in its waiting position in FIG. 6a into the friction-welding position will now be described with reference to FIGS. 6b and 6c.

First, the square-shaped ram 36 is displaced out of the position presented in FIG. 6a towards the pressure piece 33. The square cross-section of the ram 36 is indicated symbolically by the crossed lines in FIGS. 6a to c. Upon the hereinbelow mentioned rotation of the extension 37 of the annular receptacle 30, the ram 36 is not co-rotated, because the extension 37 is formed with a round hole. The ram 36 is provided at its end facing the pressure piece 33 with the spring lock washer 38, which releasably locks into corresponding seats in the housing 39 (reference character 40) and in the pressure piece 33.

FIG. 6b presents the ram 36 in a lowered position, in which it is holding the pressure piece 33 in the waiting position through the intermediary of the spring lock washer 38. Upon its continued downward motion, the ram 36 takes the pressure piece 33 with it, forcing away the arresting parts 10 and 11 towards the side (see FIG. 6c), until the fastening element 1 reaches the friction-welding position presented in FIG. 6c. The ram 36 can now be withdrawn out of its presented position. For the axial movement of the ram 36, there is provided the cylinder 53 with the therein guided piston 56, which is pneumatically operated, this being a conventional form of control which is discussed only in general principle in this connection. On account of the pneumatic forces acting on the piston 56, the piston 56 is reciprocated in the cylinder 53, thereby correspondingly taking the ram 36 with it.

Having remained in the friction-welding position (see FIG. 6c), the fastening element 1 was, prior to withdrawal of the ram 36, held in said position through the locking of pressure piece 33 and annular receptacle 30. For this purpose, the pressure piece 33 is locked to the annular receptacle 30.

To carry out such locking, the pressure piece is furnished with the dogs 34 shown in FIGS. 7 and 8, which dogs 34 engage corresponding grooves 55 in the pressure piece 30 to provide reciprocal rotation, said grooves 55 functioning together with the grooves 34 in the manner of a bayonet catch. Annular receptacle 30 and pressure piece 33 are thus axially interlocked. The ram 36 can be retracted out of said interlocking and out of its locking with the pressure piece 33 (provided by the spring lock washer 38 and the seat 40) and can be pulled back into its rear position as presented in FIG. 6a.

For carrying out the friction-welding operation, the annular receptacle 30 is set in rotation. For this purpose, the device presented in FIGS. 6a to c is provided with a rotary drive, said rotary drive consisting of the electric motor 41, which, by means of its shaft 42, rotates the gearwheel 43, which engages the step-up gearwheel 44, which, in turn, drives the gearwheel 45. Said gearwheel 45 is fixedly seated on the extension 37 of the annular receptacle 30. When the electric motor 41 rotates, the annular receptacle 30 is set in rotation according to the transmission ratios provided by the gearwheels 43 and 45, wherein, as hereinbefore described, in the friction-welding position presented in FIG. 6c, the annular receptacle 30 then—because of its interlocking with the pressure piece 33—likewise sets the pressure piece 33 in rotation, with the consequence that the fastening element 1 is set in rotation together with the pressure piece 33 at identical rotational speed, wherein, as a result of pressure on the annular receptacle 30, which, because of its interlocking with the pressure piece 33, transmits said pressure to the pressure piece 33, a corresponding pressure is exerted on the fastening element 1, which is in this manner then joined by friction-welding to a workpiece (not shown). The generation of said pressure is not a subject matter of the present invention. A mechanism generating the necessary pressure is shown in general principle in FIGS. 6a to c and 10, this being the stationary pressure generator 46, out of which protrudes the pressure transfer ram 47, which acts directly on the housing 39. As for the rest, with regard to generation of the pressure and displacement of such a device, reference is made to the already hereinbefore mentioned German patent application 10 2004 039 398.2.

Upon displacement of the housing 39, said displacement being effected through the pressure transfer ram 47, a corresponding pressure is exerted, via the roller bearings 48 disposed in the housing 39, on the extension 37 of the annular receptacle 30.

As becomes apparent from the above description, the mechanism for moving the pressure piece 33 out of its position as shown in FIG. 6a into the position as shown in FIG. 6c is not in any manner set in rotation during the friction-welding operation, i.e. said mechanism, consisting essentially of the ram 36 and the piston 56, does not contribute, with respect to its moment of inertia, to the moment of inertia of those parts which are set in rotation during friction-welding, this correspondingly facilitating the control of the friction-welding operation.

Let it additionally be pointed out that, for practical closed-loop control of the friction-welding operation, it may be necessary to measure the pressure acting on the annular receptacle 30 as well as the instantaneous rotational speed of the electric motor 41. Provided for this purpose as an abutment for the roller bearing 48 are the ring-shaped pressure sensor 49 and the revolution counter 50, which at the same time also indicates the instantaneous angular position of the shaft 42 and therefore of the annular receptacle 30. Said angular position is critical for the reason that, for the movement and locking of the pressure piece 33, as presented in FIG. 6c, said pressure piece must be detected in the correct position by the annular receptacle 30.

FIG. 7 shows a perspective view of the pressure piece 33, said pressure piece 33 being provided on its side facing the fastening element 1 with the round hole 51 and on the opposite side with the square hole 52. Said square hole 52 is engaged by the ram 36, which, when it rotates, takes the pressure piece 33 with it. Said rotation is necessary so that the pressure piece 33 is able to latch with its dogs 34 into the annular receptacle 30.

FIG. 8 presents the annular receptacle 30 and the pressure piece 33 in section along line IIX-IIX. It is apparent therefrom how the pressure piece 33, provided with three dogs 34, engages corresponding radial grooves 55 in the pressure piece 33, said radial grooves 55 functioning together with the dogs 34 in the manner of a bayonet catch.

FIG. 9 presents the device from FIGS. 6a to c in a general view. It is apparent therefrom how the cylinder 53 protrudes from the housing 39, said cylinder 53 being provided, as described hereinbefore, as a guide and drive for the movement of the ram 36. FIG. 9 also shows the tubular downholder 31 as well as the tube 7, protruding out of the housing 39, for the feeding of fastening elements 1. Next to the end of the housing 39 facing the cylinder 53, there is provided in a shoulder 54 the gear unit (see FIG. 6a), consisting of the gearwheels 43, 44 and 45, the electric motor 41 acting on said gear unit. Finally, FIG. 9 also shows the stationary pressure generator 46 with the thereby operated pressure transfer ram 47.

FIG. 10 describes a device which is extensively identical to that presented in FIGS. 6a to c, but which is designed for the processing of fastening elements in the form of nuts 57. The nut 57 has been fed in through the feeding tube 58, in the end of which is indicated by a dashed line where the nut was previously waiting. While in the waiting position, the nut 57 rests, like the fastening element 1 in the form of a stud in the illustrative embodiment in FIG. 6a, on the arresting parts 10 and 11. For engagement of the nut 57, the pressure piece 59 is provided with the projection 60, the spring lock washer 61 being latched into said projection 60. Said spring lock washer is able to latch into a corresponding groove in the nut 57. For this purpose, similarly to the procedure described in connection with FIGS. 6a to c, the pressure piece 59 is lowered and locked to the nut 57, whereupon the operations of transfer into the friction-welding position and further processing are carried out in the same manner as described in connection with FIGS. 6a to c.

1. Chuck (2) for the holding of fastening elements (1, 26), each provided with a radial pressure surface (19) and a driving profile (17), for a friction-welded connection to a component (5) and for the transmission of rotational and pressing forces acting on a fastening element (1, 26), characterized in that the chuck (2) is provided with an annular receptacle (9), having a multi-sided profile, for transmitting the rotational force, said annular receptacle (9) snugly embracing the inserted fastening element (1, 26), said fastening element (1, 26) having an axial multi-sided profile (17), wherein the chuck (2) comprises a pressure piece (18, 27), said pressure piece (18, 27) being retractable in the annular receptacle, wherein said pressure piece (18, 27) is guided by the annular receptacle (9) and is, for the feeding of a fastening element (1, 26) through a lateral opening (12) on the annular receptacle (9), retractable in the annular receptacle (9) to behind the opening (12) and is, after insertion of a fastening element (1, 26), advanceable into a waiting position against the pressure surface (19) of the fastening element (1, 26) such that, in the friction-welding position, the fastening element (1, 26) presses during its rotation against the component (5), wherein, in the waiting position, the fastening element (1, 26), inserted into the annular receptacle (9), is held in the axial direction by radially inwardly projecting, retractable arresting parts (10, 11).

2. Chuck according to claim 1, characterized in that the annular receptacle (9) narrows its external opening in the direction away from the pressure piece (18, 27) as far as contact with the fastening element (1, 26).

3. Chuck according to claim 1, characterized in that, for the processing of a stud-type fastening element (1), the pressure piece (18) is provided in the region of its hole (23) with a thereinto partially projecting clamping piece (24), wherein said clamping piece (24) clamps in easily releasable manner in the waiting position a shank of the fastening element (1), said shank being held by the hole (23).

4. Chuck according to claim 1, characterized in that, for the processing of a nut-type fastening element (26), the pressure piece (27) has an axially protruding pin (28), wherein, when the pressure piece (27) presses against the fastening element (26) in the waiting position, said pin (28) projects with a clamping piece into the threaded hole of the nut-type fastening element (26) and clamps itself releasably therein.

5. Chuck according to claim 1, characterized in that the arresting parts (10, 11) are provided with a conical support surface (21, 22) for a fastening element (1, 26) which has been fed in and is held in the waiting position, over which support surface (21, 22) the fastening element (1, 26) slides, forcing the arresting parts (10, 11) away to the side, as the fastening element (1, 26) is moved into the friction-welding position.

6. Chuck according to claim 1, characterized in that a feed channel (7) is connected to the lateral opening (12) on the annular receptacle (9), said feed channel (7) transitioning with constant narrowing of its interior space as far as adapting to the multi-sided profile of the annular receptacle (9).

7. Chuck according to claim 1, characterized in that a non-rotatable ram (36), axially displaceable in the annular receptacle (30), is provided for the displacement of the pressure piece (33, 59), wherein said ram (36) axially drivingly and releasably engages the pressure piece (33, 59) on the side thereof facing away from the fastening element (1, 57), wherein, when the fastening element (1, 57) reaches the friction-welding position, the pressure piece (33, 59) locks itself with the annular receptacle (30) in such a manner that the annular receptacle (30) transmits the thereon acting rotational forces, together with the pressing forces, to the pressure piece (33, 59), the ram (36) being released from the pressure piece (33, 59).

8. Chuck according to claim 2, characterized in that, for the processing of a stud-type fastening element (1), the pressure piece (18) is provided in the region of its hole (23) with a thereinto partially projecting clamping piece (24), wherein said clamping piece (24) clamps in easily releasable manner in the waiting position a shank of the fastening element (1), said shank being held by the hole (23).

9. Chuck according to claim 2, characterized in that, for the processing of a nut-type fastening element (26), the pressure piece (27) has an axially protruding pin (28), wherein, when the pressure piece (27) presses against the fastening element (26) in the waiting position, said pin (28) projects with a clamping piece into the threaded hole of the nut-type fastening element (26) and clamps itself releasably therein.

10. Chuck according to claim 2, characterized in that the arresting parts (10, 11) are provided with a conical support surface (21, 22) for a fastening element (1, 26) which has been fed in and is held in the waiting position, over which support surface (21, 22) the fastening element (1, 26) slides, forcing the arresting parts (10, 11) away to the side, as the fastening element (1, 26) is moved into the friction-welding position.

11. Chuck according to claim 3, characterized in that the arresting parts (10, 11) are provided with a conical support surface (21, 22) for a fastening element (1, 26) which has been fed in and is held in the waiting position, over which support surface (21, 22) the fastening element (1, 26) slides, forcing the arresting parts (10, 11) away to the side, as the fastening element (1, 26) is moved into the friction-welding position.

12. Chuck according to claim 4, characterized in that the arresting parts (10, 11) are provided with a conical support surface (21, 22) for a fastening element (1, 26) which has been fed in and is held in the waiting position, over which support surface (21, 22) the fastening element (1, 26) slides, forcing the arresting parts (10, 11) away to the side, as the fastening element (1, 26) is moved into the friction-welding position.

13. Chuck according to claim 2, characterized in that a feed channel (7) is connected to the lateral opening (12) on the annular receptacle (9), said feed channel (7) transitioning with constant narrowing of its interior space as far as adapting to the multi-sided profile of the annular receptacle (9).

14. Chuck according to claim 3, characterized in that a feed channel (7) is connected to the lateral opening (12) on the annular receptacle (9), said feed channel (7) transitioning with constant narrowing of its interior space as far as adapting to the multi-sided profile of the annular receptacle (9).

15. Chuck according to claim 4, characterized in that a feed channel (7) is connected to the lateral opening (12) on the annular receptacle (9), said feed channel (7) transitioning with constant narrowing of its interior space as far as adapting to the multi-sided profile of the annular receptacle (9).

16. Chuck according to claim 5, characterized in that a feed channel (7) is connected to the lateral opening (12) on the annular receptacle (9), said feed channel (7) transitioning with constant narrowing of its interior space as far as adapting to the multi-sided profile of the annular receptacle (9).
